(19) United States
(12) Patent Application Publication
(10) Pub. No.: US 2015/0296039 A1
(43) Pub. Date: Oct. 15, 2015

(54) METHOD AND SYSTEM FOR DOCUMENT PROCESSING IN WIRELESS COMMUNICATION APPARATUS

(71) Applicant: HUIZHOU TCL MOBILE COMMUNICATION CO., LTD., Hui Zhou (CN)

(72) Inventor: Zhibing Yang, Huizhou (CN)

(21) Appl. No.: 14/439,151

(22) PCT Filed: Apr. 16, 2014
(86) PCT No.: PCT/CN2014/075527

§ 371 Date: Apr. 28, 2015

(30) Foreign Application Priority Data
Jul. 3, 2013 (CN) 201310276663.1

(51) Int. Cl. H04L 29/08; H04L 29/06; H04W 4/18

(52) U.S. Cl. CPC H04L 67/2823; H04W 4/18; H04L 67/42

(57) ABSTRACT

A method and a system for document processing in a wireless communication apparatus may include, upon receiving a document of an unidentifiable type, a wireless communication apparatus that sends the document to a network server via a wireless communication module. Upon receiving the document sent by the wireless communication apparatus, the network server carries out a document type conversion processing, and sends the converted document to the wireless communication apparatus via a wireless network. Upon receiving the document converted by the network server, the wireless communication apparatus opens the document by calling a corresponding application with a document processing module. The method and system makes use of the processing capability of a network server to carry out a conversion processing on a document of an unidentifiable type. Thus, the wireless communication apparatus does not need to install a large quantity of document processing applications.

### TECHNICAL FIELD

The present disclosure relates to wireless communication apparatuses. More particularly, the present disclosure relates to a method and a system for document processing in a wireless communication apparatus.

### BACKGROUND

As wireless communication apparatuses become increasingly common and continue to have enhanced processing capabilities, people will use wireless communication apparatuses to process more and more information. Many things that used to be processed on a PC can now be processed on a wireless communication apparatus, such as mail, going online, chatting and document processing. Along with the arrival of the 3G and 4G era, seamless connection is formed between a wireless communication apparatus and a PC via a wireless network, which further enables the wireless communication apparatus to handle additional tasks. However, there are many types of documents that need to be processed in daily work. On the other hand, the hardware resources and processing capabilities of a wireless communication apparatus are limited, e.g. low memory, insufficient CPU processing capability, insufficient storage space and the like. As a result, applications of various types need to be installed if it is desired that a wireless communication apparatus process all types of documents. However, some applications cannot be installed on a wireless communication apparatus. As a result, there are still documents of many types that cannot be directly viewed on a wireless communication apparatus, such as EXCEL documents, MPP documents, etc. When a wireless communication apparatus receives documents of these types, the documents cannot be viewed, and it is impossible to perform further processing according to the information in the documents.

Therefore, the prior art is in need of improvement and development.

### SUMMARY

The methods and systems of the present disclosure cure the deficiencies and drawbacks of the prior art by providing document processing in a wireless communication apparatus. The document processing can process a document and convert the document to a format that can be opened by the wireless communication apparatus, such that the wireless communication apparatus can view documents of all types.

A method for document processing in a wireless communication apparatus includes upon receiving a document of an unidentifiable type, a wireless communication apparatus sends the document to a network server via a wireless communication module; upon receiving the document sent by the wireless communication apparatus, the network server carries out a document type conversion processing, and sends the converted document to the wireless communication apparatus via a wireless network; upon receiving the document converted by the network server, the wireless communication apparatus opens the document by calling a corresponding application with a document processing module.

In another embodiment, a method for document processing in a wireless communication apparatus includes pre-assigning an identification number to the wireless communication apparatus for differentiating different wireless communication apparatuses, a network server identifying said wireless communication apparatus with said identification number and establishing a network link.

In a further embodiment, a method for document processing in a wireless communication apparatus includes a network server carrying out a processing on a document sent by the wireless communication apparatus for document type conversion and, upon receiving document data, a network server performs type identification on said document, reads a document type, and activates a corresponding application on the network server to open said document for document conversion.

In yet another embodiment, a method for document processing in a wireless communication apparatus includes a corresponding application on a network server opening a document for document conversion is to correspondingly covert the document to a document of an image format sequentially and save the document of the image format sequentially.

In yet a further embodiment, a method for document processing in a wireless communication apparatus includes a wireless communication apparatus, receiving a document converted by a network server, establishing a corresponding independent folder for each document, and saving the received document of an image format as converted by the network server sequentially into said corresponding independent folder.

In another embodiment, a method for document processing in a wireless communication apparatus includes a network server that performs typesetting on a converted document according to information of the original document; and the wireless communication apparatus saves the received converted document according to certain rules and manages the converted document according to certain rules.

In a further embodiment, a method for document processing in a wireless communication apparatus includes a user opens a document through a wireless communication apparatus for identification processing by a document processing module to determine the type of said document, if the document is a document that can be identified by the wireless communication apparatus, setting said document as an identifiable document, and transferring a corresponding file type to a system and displaying with a document icon of the corresponding type; if the document is a document that cannot be identified by the wireless communication apparatus, setting said document as an unidentifiable document type; upon receiving a document of an unidentifiable type, a wireless communication apparatus sends the document to a network server via a wireless communication module; upon receiving the document sent by the wireless communication apparatus, the network server carries out a document type conversion processing, and sends the converted document to the wireless communication apparatus via a wireless network; upon receiving the document converted by the network server, the wireless communication apparatus opens the document by calling a corresponding application with a document processing module.

In yet another embodiment, a system for document processing in a wireless communication apparatus includes a wireless communication apparatus and a network server, wherein the wireless communication apparatus and the network server form a communication link via a wireless network; said wireless communication apparatus comprises a document processing module and a wireless communication module; said document processing module is configured to process documents on the wireless communication apparatus, including determination of document types, and opening or closing of a document; said wireless communication module is configured to, over a wireless link, upload a document in the wireless communication apparatus to said network server or to receive a corresponding document from said network server and transmit the document to the document processing module for processing; and said network server is configured to receive a document uploaded by the wireless communication apparatus and carry out document conversion according to the document type, and to download the converted document to the wireless communication apparatus.

In yet a further embodiment, a system for document processing in a wireless communication apparatus includes a document processing module determining a type of a document during document processing comprises performing identification processing on the document, if the document is a document that can be identified by the wireless communication apparatus, setting said document as an identifiable document, and transferring a corresponding file type to the system and displaying with a document icon of the corresponding type; and if the document is a document that cannot be identified by the wireless communication apparatus, setting said document as an unidentifiable document type.

In another embodiment, a system for document processing in a wireless communication apparatus includes a network server receiving a document uploaded by the wireless communication apparatus and carrying out document conversion according to a document type is to correspondingly covert the document to a document of an image format sequentially and save the document of the image format sequentially.

In a further embodiment, a system for document processing in a wireless communication apparatus includes a document processing module configured to, upon receiving a converted document transmitted by a network server, establish a corresponding independent folder for each document, and save the received document of an image format, as converted by the network server, sequentially into a corresponding independent folder.

In yet another embodiment, a system for document processing in a wireless communication apparatus includes a network server configured to perform typesetting on a converted document according to information of the original document.

In yet a further embodiment, a system for document processing in a wireless communication apparatus includes a document processing module configured to save a received converted document according to certain rules and manage the converted document according to certain rules.

Compared with the prior art, the processing method and system of the present disclosure facilitate a user to view documents of various types on a wireless communication apparatus. When performing document processing, the wireless communication apparatus identifies the type of the document. In the event of a document that cannot be opened and processed, the wireless communication apparatus sends the document to a network server. The network server converts the document to a document format that the wireless communication apparatus can open, and downloads the converted document to the wireless communication apparatus. Thereby, the wireless communication apparatus can open the document that the wireless communication apparatus was previously unable to open. By making use of the powerful processing capability of a network server to carry out a conversion processing on a document unidentifiable by a wireless communication apparatus, the wireless communication apparatus does not need to install a large quantity of document processing applications, which saves storage space for the wireless communication apparatus. Thereby, the wireless communication apparatus can view documents of any type, which enhances the wireless communication apparatus' document processing capability and facilitates use by users.

### BRIEF DESCRIPTION OF THE DRAWINGS

FIG. 1 depicts a flow chart of an exemplary method for document processing in a wireless communication apparatus; and

FIG. 2 depicts a logic structural block diagram of an exemplary system for document processing in a wireless communication apparatus.

### DETAIL DESCRIPTION

To make the objects, technical solutions and advantages of the method and system for document processing in a wireless communication apparatus clear, the methods and systems are described in detail below with reference to the accompanying drawings and exemplary embodiments. It should be understood that the exemplary embodiments are for illustrative purposes only. The exemplary embodiments are not intended to limit the claimed invention in any way.

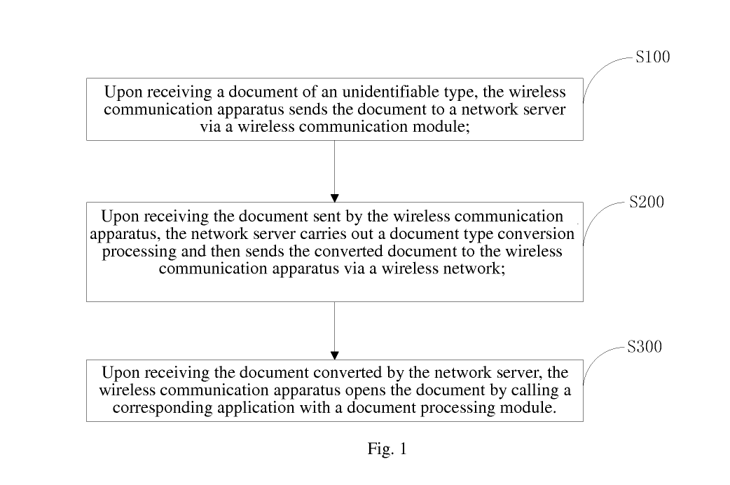

Turning to FIG. 1, a flow chart of a method for document processing in a wireless communication may include, upon receiving a document of an unidentifiable type, the wireless communication apparatus may send the document to a network server via a wireless communication module (block S100). Prior to receiving a document of an unidentifiable type by the wireless communication apparatus, a user may open a document through the wireless communication apparatus for identification processing by a document processing module to determine the type of said document. If the document is a document that can be identified by the wireless communication apparatus, the document may be set as an identifiable document, and transferring the corresponding file type to the system and displaying with a document icon of the corresponding type. If the document is a document that cannot be identified by the wireless communication apparatus, the document may be set as an unidentifiable document type. Upon receiving a document sent by the wireless communication apparatus, a network server may carry out a document type conversion processing and may send the converted document to the wireless communication apparatus via a wireless network (block S200). To enable automatic identification between the network server and the wireless communication apparatus, an identification number may be pre-assigned to the wireless communication apparatus for differentiating different wireless communication apparatuses. Subsequently, the network server may identify the wireless communication apparatus with the identification number and may establish a network link. Upon receiving the document data, the network server may perform type identification on said document, may read the document type, and may activate a corresponding application on the network server to open the document for document conversion. When the corresponding application, on the network server, opens the document for document conversion the application may correspondingly covert the document to a document of an image format sequentially and may save the document of the image format sequentially. Upon receiving the document converted by the network server, the wireless communication apparatus may open the document by calling a corresponding application with a document processing module (block S300). To enable a wireless communication apparatus to correctly call the corresponding document, a corresponding independent folder may be established for each document and the received document of an image format may be saved as converted by the network server sequentially into the corresponding independent folder.

In terms of document management by the wireless communication apparatus, to enable the converted document to match the original document (for example, when a PDF document or an EXCEL table is converted to a JPG document), the converted document may be typeset according to information of the original document at the network server. The wireless communication apparatus may save the received converted document according to certain rules and may manage the converted document according to certain rules, such that the user can conveniently operate on the converted document, e.g. viewing or management.

Before the network server converts each document, the network server may first obtain information corresponding to the current document via a corresponding application, including a name, document type, and document length (e.g. page number of the document) of the current document. According to a sequence of the original document, the network server may, for example, convert every page of the document to a JPG image. When the conversion is completed, to make the converted document orderly and easy to manage, the network server may, for example, name the JPG image of each page according to certain rules, such that the name of the JPG image file of each page includes, for example: name+type+page number. Each part of the name of the JPG image file may have a fixed number of character digits, for example, the name may have 20 digits, the type may have 2 digits and the page number may have 5 digits.

The “name” may be, for example, a code of the original document name after conversion. With respect to the information, names of all converted files may contain names of the original documents corresponding thereto. Therefore, the document to which the converted document corresponds may be learned according to the information. Upon receiving the converted JPG document, the wireless communication apparatus may learn the name of the corresponding original document according to the name therein. The “type” may be, for example, a code of the original document type after conversion (each type corresponding to a two digit number combination). With the information, the corresponding document type prior to the conversion to the current JPG document may be learned. The “page number” may be, for example, the number of the page that the original document is on, and the information makes the converted document correspond to the document position in the original document. In such a way, each JPG document may include relevant information, such as the document name and page number. When the original document is converted, the network server may send the converted JPG documents one by one, in the sequence of conversion, to the wireless communication apparatus.

To facilitate management of received converted documents, upon receiving the first document, the wireless communication apparatus may create an independent folder at a specific position of the document system according to the information contained in the document, such as name, type and the like, and may use the code of document name as the folder name. Accordingly, the wireless communication apparatus may subsequently save all received JPG documents converted from the original document into the folder. In such a way, the JPG documents converted from different documents may be saved into independent folders on the mobile terminal, which facilitates independent management thereof by a user. Since all JPG document names may contain corresponding page numbers in the original document prior to the conversion, it is very easy to learn the content in the original document that the converted JPG documents correspond to. When it is desired to view the documents, therefore, a user can view the documents according to the sequential process of the original document. When the user views a document with a wireless communication apparatus, the document processing module may play the JPG documents according to the sequence of the name and page number fields of the JPG documents, which may follow the sequence of the original document, and may make the viewing sequence consistent. The user may choose to view the information of certain pages according to the page numbers of the JPG documents.

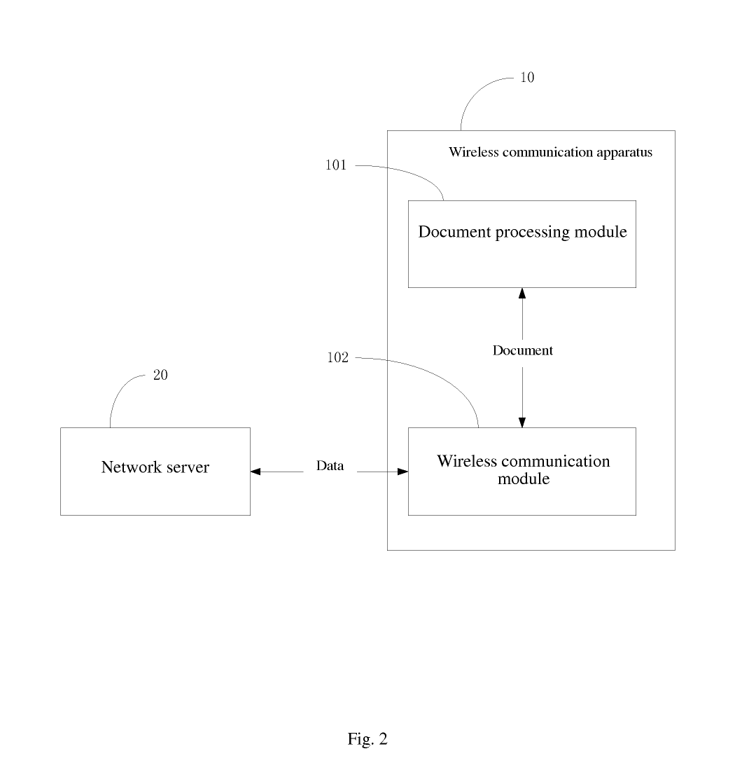

A system for document processing in a wireless communication apparatus is shown in FIG. 2, and may include a wireless communication apparatus 10 and a network server 20. The wireless communication apparatus 10 and the network server 20 may form a communication link via a wireless network. The wireless communication apparatus 10 may also include a document processing module 101 and a wireless communication module 102. The document processing module 101 may be configured to process documents on the wireless communication apparatus, including determination of document types, and opening or closing of a document.

The wireless communication module 102 may be configured to, over a wireless link, upload a document in the wireless communication apparatus to the network server or to receive a corresponding document from the network server, and may transmit the document to the document processing module for processing. The network server 20 may be configured to receive a document uploaded by the wireless communication apparatus and may carry out document conversion according to the document type, and may download the converted document to the wireless communication apparatus.

Determination of the type of a document during document processing by the document processing module 101 may include performing identification processing on the document. If the document is a document that can be identified by the wireless communication apparatus, the document may be set as an identifiable document, the document may be transferred, in the corresponding file type, to the system, and may be displayed with a document icon of the corresponding type. If the document is a document that cannot be identified by the wireless communication apparatus, the document may be set as an unidentifiable document type.

The network server may receive a document uploaded by the wireless communication apparatus, and may carry out document conversion according to the document type. The network server may correspondingly covert the document to a document of an image format sequentially, and may save the document of the image format sequentially.

The document processing module may be further configured to, upon receiving the converted document transmitted by said network server, establish a corresponding independent folder for each document, and may save the received document of an image format as converted by the network server sequentially into the corresponding independent folder. The specific working principle of the system may be the same as that of the above method, which will not be repeated herein.

It should be understood that exemplary embodiments of the present invention are described above, which are not intended to restrict the technical solution of the present invention in any way. To those skilled in the art, addition, deletion, substitution, modification or improvement may be made according to the above description within the spirit and principle of the present invention. While all technical solutions after the addition, deletion, substitution, modification or improvement shall be encompassed by the scope of the appended claims.

1. A method for document processing in a wireless communication apparatus, the method comprising:
upon receiving a document of an unidentifiable type, a wireless communication apparatus sends the document to a network server via a wireless communication module;
upon receiving the document sent by the wireless communication apparatus, the network server carries out a document type conversion processing, and sends the converted document to the wireless communication apparatus via a wireless network;
upon receiving the document converted by the network server, the wireless communication apparatus opens the document by calling a corresponding application with a document processing module.

2. The method for document processing in a wireless communication apparatus according to claim 1, further comprising:
pre-assigning an identification number to the wireless communication apparatus for differentiating different wireless communication apparatuses, said network server identifying said wireless communication apparatus with said identification number and establishing a network link.

3. The method for document processing in a wireless communication apparatus according to claim 2, wherein the network server carrying out a processing on the document sent by the wireless communication apparatus for document type conversion,
upon receiving document data, the network server performs type identification on said document, reads the document type, and activates a corresponding application on the network server to open said document for document conversion.

4. The method for document processing in a wireless communication apparatus according to claim 3, wherein the application on the network server opening said document for document conversion is to correspondingly covert the document to a document of an image format sequentially and save the document of the image format sequentially.

5. The method for document processing in a wireless communication apparatus according to claim 4, wherein said wireless communication apparatus receiving the document converted by the network server further comprises:
establishing a corresponding independent folder for each document, and saving the received document of an image format as converted by the network server sequentially into said corresponding independent folder.

6. The method for document processing in a wireless communication apparatus according to claim 1,
further comprising: the network server performs typesetting on the converted document according to information of the original document; and
the wireless communication apparatus saves the received converted document according to certain rules and manages the saved converted document according to certain rules.

7. A method for document processing in a wireless communication apparatus, the method comprising:
a user opens a document through a wireless communication apparatus for identification processing by a document processing module to determine the type of said document, if the document is a document that can be identified by the wireless communication apparatus, setting said document as an identifiable document, and transferring a corresponding file type to a system and displaying with a document icon of the corresponding type; if the document is a document that cannot be identified by the wireless communication apparatus, setting said document as an unidentifiable document type;
upon receiving a document of an unidentifiable type, a wireless communication apparatus sends the document to a network server via a wireless communication module;
upon receiving the document sent by the wireless communication apparatus, the network server carries out a document type conversion processing, and sends the converted document to the wireless communication apparatus via a wireless network;
upon receiving the document converted by the network server, the wireless communication apparatus opens the document by calling a corresponding application with a document processing module.

8. The method for document processing in a wireless communication apparatus according to claim 7, further comprising:
pre-assigning an identification number to the wireless communication apparatus for differentiating different wireless communication apparatuses, said network server identifying said wireless communication apparatus with said identification number and establishing a network link.

9. The method for document processing in a wireless communication apparatus according to claim 8, wherein the network server carrying out a processing on the document sent by the wireless communication apparatus for document type conversion,
upon receiving document data, the network server performs type identification on said document, reads the document type, and activates a corresponding application on the network server to open said document for document conversion.

10. The method for document processing in a wireless communication apparatus according to claim 9, wherein the application on the network server opening said document for document conversion is to correspondingly covert the document to a document of an image format sequentially and save the document of the image format sequentially.

11. The method for document processing in a wireless communication apparatus according to claim 10, wherein said wireless communication apparatus receiving the document converted by the network server further comprises:
establishing a corresponding independent folder for each document, and saving the received document of an image format as converted by the network server sequentially into said corresponding independent folder.

12. The method for document processing in a wireless communication apparatus according to claim 7,
further comprising: the network server performs typesetting on the converted document according to information of the original document; and
the wireless communication apparatus saves the received converted document according to certain rules and manages the saved converted document according to certain rules.

13. A system for document processing in a wireless communication apparatus, the system comprising:
a wireless communication apparatus and a network server wherein the wireless communication apparatus and the network server form a communication link via a wireless network;
said wireless communication apparatus comprises a document processing module and a wireless communication module; said document processing module is configured to process documents on the wireless communication apparatus, including determination of document types, and opening or closing of a document;
said wireless communication module is configured to, over a wireless link, upload a document in the wireless communication apparatus to said network server or to receive a corresponding document from said network server and transmit the document to the document processing module for processing; and
said network server is configured to receive a document uploaded by the wireless communication apparatus and carry out document conversion according to the document type, and to download the converted document to the wireless communication apparatus.

14. The system for document processing in a wireless communication apparatus according to claim 13, wherein said document processing module determining the type of a document during document processing comprises performing identification processing on the document.

15. The system for document processing in a wireless communication apparatus according to claim 13, wherein said network server receiving a document uploaded by the wireless communication apparatus and carrying out document conversion according to the document type is to correspondingly covert the document to a document of an image format sequentially and save the document of an image format sequentially.

16. The system for document processing in a wireless communication apparatus according to claim 15, wherein said document processing module is further configured to, upon receiving the converted document transmitted by said network server, establish a corresponding independent folder for each document, and save the received document of an image format as converted by the network server sequentially into said corresponding independent folder.

17. The system for document processing in a wireless communication apparatus according to claim 13, wherein
said network server is further configured to perform typesetting on the converted document according to the information of the original document.

18. The system for document processing in a wireless communication apparatus according to claim 14, wherein if the document is a document that can be identified by the wireless communication apparatus, setting said document as an identifiable document, and transferring a corresponding file type to the system and displaying with a document icon of the corresponding type.

19. The system for document processing in a wireless communication apparatus according to claim 14, wherein if the document is a document that cannot be identified by the wireless communication apparatus, setting said document as an unidentifiable document type.

20. The system for document processing in a wireless communication apparatus according to claim 13, wherein said document processing module is further configured to save the received converted document according to certain rules and manage the converted document according to certain rules.
